(19) United States
(12) Patent Application Publication
(10) Pub. No.: US 2025/0270920 A1
(43) Pub. Date: Aug. 28, 2025

(54) Determining Core-Log Depth Corrections for Hydrocarbon Exploration

(71) Applicant: Saudi Arabian Oil Company, Dhahran (SA)

(72) Inventors: Fatai A. Anifowose, Al-Khobar (SA); Maimona Mohamed Ibrahim Washie, Dhahran (SA)

(21) Appl. No.: 18/588,721

(22) Filed: Feb. 27, 2024

(51) Int. Cl. E21B 47/04; E21B 47/09; E21B 47/12; E21B 49/02; E21B 49/08

(52) U.S. Cl. CPC E21B 47/04; E21B 47/09; E21B 47/12; E21B 49/02; E21B 49/088; E21B 2200/22

(57) ABSTRACT

A method for determining a core-log depth correction between one or more wireline log measurements and one or more core sample measurements of a well, where the well is drilled for hydrocarbon exploration or extraction. The method includes training a machine learning model to determine a correlation between wireline logs obtained with down-hole logging tools and rock properties of a subsurface evaluated in the region of the well.

### TECHNICAL FIELD

The present disclosure relates to wellbore drilling, such as for hydrocarbon extraction. More specifically, the disclosure describes techniques for determining a core-log depth correction for core measurements of rock properties.

### BACKGROUND

Wireline logging is a technique in the field of hydrocarbon exploration and extraction that includes lowering measurement tools into a well on a wireline to record continuous measurements of various physical properties of the rock and fluid contents of the subsurface environment. The tools can measure properties such as electrical resistivity, gamma radiation, and acoustic properties. Information obtained from wireline logs can help plan the trajectory of future drilling operations and selecting zones for hydrocarbon extraction.

Core sample extraction is a technique in the field of hydrocarbon exploration and extraction that includes extracting cylindrical sections of rock directly from the subsurface at various depths of the well. The core samples are extracted with a specialized drill bit and brought to the surface inside a core barrel, where the core sample is preserved and label according to the corresponding depth of extraction. Evaluation of the core samples provide measurements of physical rock properties that include porosity, permeability, grain density, and elemental data of the subsurface.

### SUMMARY

This specification describes techniques that can be used for core-log depth correction, where an evaluation of rock properties from core samples are correlated with predicted values of the same rock properties determined by wireline logs. Wireline logs are often obtained after a well has been drilled, where one or more logging tools are lowered into the well to collect measurements corresponding to multiple properties of the subsurface including gamma ray levels, neutron porosity, density, spontaneous potential, and sonic shear. In addition, core samples, often obtained while drilling, can be analyzed to evaluate multiple rock properties of the subsurface including porosity, permeability, grain density, and other elemental characteristics. The data from core samples and wireline logs are obtained under different environments, with different crew members, and with a different set of tools. Therefore, a depth correction (e.g., a core-log depth correction) is necessary when comparing the data obtained by core sample analysis with data obtained by a wireline log.

A common approach to align a set of corresponding measurements along the depth of the well between the core sample evaluation and the wireline logs is with core gamma measurements. For example, by analyzing the gamma ray levels of core samples and correlating the levels with a set of gamma ray wireline log measurements, a core-log depth correction can be obtained. A multivariate approach that correlates multiple parameters of wireline logs with associated rock properties (e.g., the rock properties obtained from core samples) provides core-log depth correction in wells and sections of wells without core samples.

This specification describes a multivariate approach to determine a correlation between a set of rock properties from core samples with a set of pseudo-logs corresponding to the same rock properties as determined by a corresponding set of wireline logs from one or more wells. The correlation can be determined by training a machine learning model to learn a pattern between a wireline log, where the wireline log includes measurements of various subsurface properties, and a predicted set of rock properties. The correlation can provide a core-log depth correction for wells without core samples and for sections of wells without core samples. By identifying a relationship between wireline logs and rock properties through training a machine learning model using core sample data and wireline logs as training data, a predicted core-log depth correction is obtained without requiring core samples from additional wells.

Implementations of the systems and methods of this disclosure can provide various technical benefits. A core-log depth correction can be obtained for wells without core samples and for sections of wells without core samples, which reduces a necessity for collecting core samples from every section of every well in a region. In addition, gamma ray levels are not always measured for collected core samples in the field. The systems and methods of this disclosure offer a solution for determining core-log depth correction for wells with core samples but without gamma ray measurements. The systems and methods of this disclosure offer a predictive core-log depth correction for a well without the need for core samples from the particular well. Using multiple rock properties inferred from wireline logs (e.g., pseudo-logs), a multivariate correlation between the predicted multiple rock properties and measured rock properties from core samples offers a more precise correlation compared to previous approaches that use a single variable (e.g., correlating gamma ray levels).

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a exploration activities being performed to map subsurface features of a reservoir.

FIG. 2 is a block diagram showing an example process for correcting the depth values of a core-log measurement of a well.

FIG. 3 is a schematic illustrating a process for training and validating a machine learning model to predict a set of rock properties of a well.

FIG. 4 is a schematic illustrating the input data and output predictions for a machine learning model trained to predict a set of rock properties of a well.

FIG. 5 illustrates a difference between a set of core-log measurements of a well and a set of predicted values from a machine learning model for an evaluation of titanium dioxide (TiO₂).

FIG. 6 illustrates a difference between a set of core-log measurements of a well and a set of predicted values from a machine learning model for an evaluation of silicon dioxide (SiO₂).

FIG. 7 illustrates a difference between a set of core-log measurements of a well and a set of predicted values from a machine learning model for an evaluation of potassium oxide (K₂O).

FIG. 8 illustrates a difference between a set of core-log measurements of a well and a set of predicted values from a machine learning model for an evaluation of uranium.

FIG. 9 is a schematic illustrating field operations to produce hydrocarbons.

FIG. 10 is a diagram of an example computing system.

Like reference numbers and designations in the various drawings indicate like elements.

### DETAILED DESCRIPTION

This specification describes techniques that can be used for core-log depth correction, where an evaluation of rock properties from core samples are correlated with predicted values of the same rock properties determined by wireline logs. Wireline logs are often obtained after a well has been drilled, where one or more logging tools are lowered into the well to collect measurements corresponding to multiple properties of the subsurface including gamma ray levels, neutron porosity, density, spontaneous potential, and sonic shear. In addition, core samples, often obtained while drilling, can be analyzed to evaluate multiple rock properties of the subsurface including porosity, permeability, grain density, and other elemental characteristics. The data from core samples and wireline logs are obtained under different environments, with different crew members, and with a different set of tools. Therefore, a depth correction (e.g., a core-log depth correction) is necessary when comparing the data obtained by core sample analysis with data obtained by a wireline log.

This specification describes a multivariate approach to determine a correlation between a set of rock properties from core samples with a set of pseudo-logs corresponding to the same rock properties as determined by a corresponding set of wireline logs from one or more wells. The correlation can be determined by training a machine learning model to learn a pattern between a wireline log, where the wireline log includes measurements of various subsurface properties, and a predicted set of rock properties. The correlation can provide a core-log depth correction for wells without core samples and for sections of wells without core samples. By identifying a relationship between wireline logs and rock properties through training a machine learning model using core sample data and wireline logs as training data, a predicted core-log depth correction is obtained without requiring core samples from additional wells.

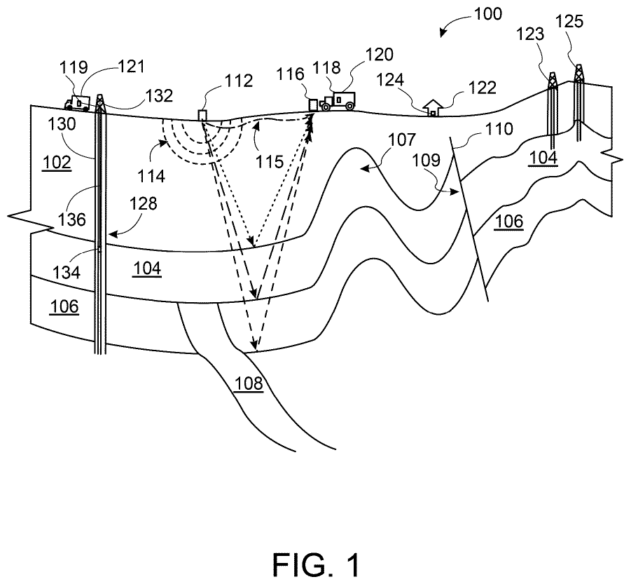

FIG. 1 is a schematic view of exploration activities being performed to map subsurface features in a subsurface formation 100. Seismic surveys along with wireline logs and core samples from wells in the subsurface can provide a comprehensive evaluation of the structure of the subsurface formation 100. For example, correlating the seismic survey with wireline logs and core samples can lead to a prediction of the subsurface rock properties at multiple depths of the subsurface, and help identify regions for further exploring and extraction of hydrocarbons from a reservoir.

The subsurface formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subsurface formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1, the source or sources 112 are typically a line or an array of sources 112. The generated seismic waves include seismic body waves 114 that travel into the ground and seismic surface waves 115 travel along the ground surface and diminish as they get further from the surface.

The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems that provide additional information about the subsurface formation. For example, the control center 122 can receive data from a computer 119 associated with a well logging unit 121.

The computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

In some embodiments, a wellbore 130 that has been drilled in the subsurface formation 100 is logged in a well logging operation 128. The wellbore 130 extends downhole from a wellhead 132. The wellbore 130 is a vertical wellbore but well logging can also be performed in other wellbores, for example, slanted or horizontal wellbores. In the well logging operation 128, the wellbore 130 penetrates through three layers 102, 104, and 106 of a subsurface formation 100. A control truck 121 lowers a logging tool 134 down the wellbore 130 on a wireline 136.

The logging tool 134 is string of one or more instruments with sensors operable to measure geophysical properties of the subsurface formation 100. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically a function of lithology and rock texture but particularly porosity. The logging tool consists of a piezoelectric transmitter and receiver and the time taken for the sound wave to travel the fixed distance between the two is recorded as an interval transit time.

As the logging tool 134 travels downhole, measurements of formations properties are recorded to generate a well log. In the illustrated operation, the data are recorded at the control truck 121 in real-time. Real-time data are recorded directly against measured cable depth. In some well-logging operations, the data is recorded at the logging tool 134 and downloaded later. In this approach, the downhole data and depth data are both recorded against time. The two data sets are then merged using the common time base to create an instrument response versus depth log.

In the well logging operation 128, the well logging is performed on a wellbore 110 that has already been drilled. In some operations, well logging is performed in the form of logging while drilling techniques. In these techniques, the sensors are integrated into the drill string and the measurements are made in real-time, during drilling rather than using sensors lowered into a well after drilling.

The computer systems 124 in the control center 122 can be configured to analyze, model, control, optimize, or perform management tasks of field operations associated with development and production of resources such as oil and gas from the subsurface formation 100. For example, an injection well 123 and a production well 125 extend into layer 104 of the subsurface formation 100. Based on data gathered by the exploratory field operations, the computer systems 124 can generate models such as a reservoir model for portions of the subsurface formation 100. These models can simulate the effects of production field operations (e.g., injecting water or carbon dioxide through the injection well 123 to increase the production of hydrocarbons through the production well 125). The simulations can be used to plan and, in some instances, control field operations (e.g., the operation of pumps associated with the injection well 123 and the production well 125).

In some embodiments, results generated by the computer systems 124 may be displayed for user viewing using local or remote monitors or other display units. One approach to analyzing seismic data is to associate the data with portions of a seismic cube representing the subsurface formation 100. The seismic cube can also display results of the analysis of the seismic data associated with the seismic survey.

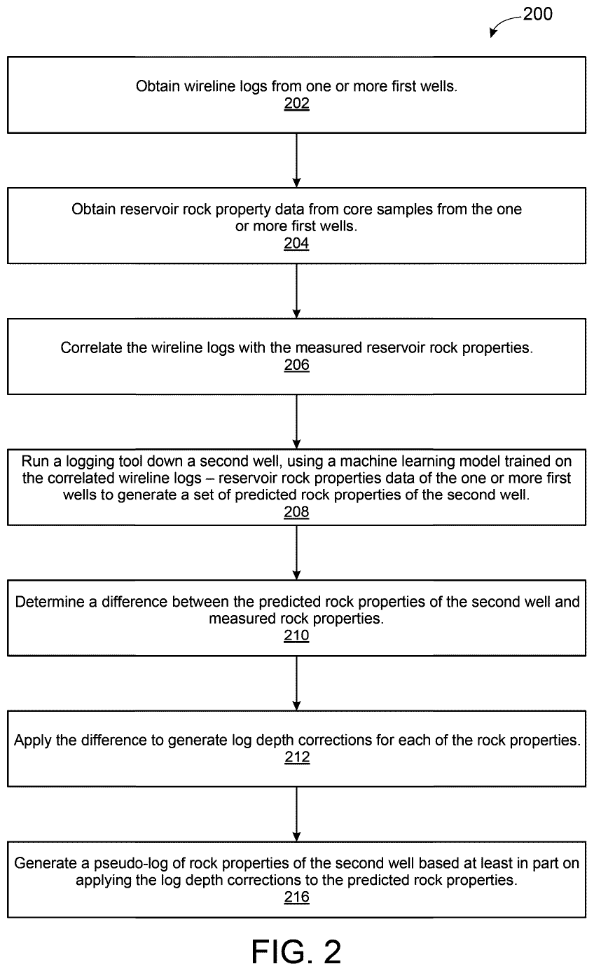

FIG. 2 is a block diagram illustrating an example process 200 for generating a pseudo-log of rock properties of a well using a machine learning model trained using correlations between wireline logs and core samples from one or more wells, according to some implementations of the present disclosure. For clarity of presentation, the description that follows generally describes process 200 in the context of the other figures in this description. However, it will be understood that process 200 can be performed, for example, by any suitable system, environment, software, and hardware, or a combination of systems, environments, software, and hardware, as appropriate. In some implementations, various steps of process 200 can be run in parallel, in combination, in loops, or in any order.

The process 200 includes a system that obtains (202) wireline logs from one or more first wells. Wireline logging is a method used to obtain detailed reservoir rock properties of a subsurface formation (i.e., subsurface formation 100) in a well. The method includes lowering a logging tool, where the logging tool can be a string of measurement instruments, down a well (i.e., wellbore 130) on a wireline. The wireline is a thin cable used to lower and raise the logging tool. In some cases, the wireline longs are stored in a database from previous logging activities. In some other cases, the wireline logs are obtained from new wells during new logging activities.

In some implementations, the wireline logs from each of the one or more first wells provide measurements of properties of the corresponding subsurface formation that include gamma ray emission, neutron porosity, density, spontaneous potential, sonic compression, and sonic shear. Measurement devices on the logging tool that is lowered down each of the one or more first wells obtain the properties of the corresponding subsurface formation. For example, a gamma ray logging tool that can include a scintillation detector can evaluate the gamma ray emission of a portion of the subsurface by measuring the natural radioactivity of the subsurface material. In some cases, shale and non-shale formations emit different levels of radioactivity, which can provide insight into the composition of the subsurface as a function of depth. As another example, by evaluating the thermalization rate of neutrons sent through the subsurface material, the neutron porosity of a portion of the subsurface can be obtained, where a Helium-3 (He-3) detector measures the thermalized neutrons and an Americium-Beryllium (Am—Be) neutron source generates the emitted neutrons. In general, the logging tool can include one or more source of neutrons, acoustic signals, electrical current and detectors to detect radioactivity, reflected sonic waves, electrical resistivity, or any other source or detector to evaluate properties of the subsurface formation.

The wireline logs of the subsurface formation from each of the one or more first wells include one or more sequence of ordered pairs, where each sequence corresponds to a physical property of the subsurface as evaluated by a measurement device on the logging tool. Each ordered pair includes a depth value and a measured physical property value. For example, an ordered pair corresponding to the gamma ray emission at a first well of the one or more first wells at a particular depth di is (di, gi), where g; is the measured gamma ray emission at depth di according to the wireline log. In this example, the sequence of ordered pairs corresponding to the gamma ray emission at all depths of the first well includes all values of di corresponding to the full measured depth of the first well. The logging tool can obtain a similar sequence of ordered pairs for each physical property of the subsurface for the first well, and the same set of sequences of ordered pairs for each well of the one or more first wells.

The system obtains (204) reservoir rock property data from core samples from the one or more first wells. The core reservoir rock property data can be stored in a database or collected directly from wells. Core samples provide direct physical measurements of the subsurface rock formation. In some cases, the core samples are cylindrical sections of rock extracted from the subsurface through drilling operations. Core samples can provide a measurement of the subsurface porosity, permeability, grain density, and elemental data properties at the depth from which the core sample is collected.

The system correlates (206) the wireline logs with the measured reservoir rock properties. In some cases, the measured values from the wireline logs are different from the measured values from the core samples. However, one or more measured values from the wireline logs can be correlated to one or more measured values from the core samples. For example, as an example of a wireline log, a neutron log may correlate closely with a porosity measurement of a core sample at corresponding depths, because the values measured in a neutron log can be affected by the porosity of the subsurface.

The system trains a machine learning model to identify correlations between the wireline logs and the measured reservoir rock properties. In some implementations, the machine learning model is an artificial neural network. The artificial neural network includes one or more hidden layers, the one or more hidden layers including a summation layer as a linear function and an activation layer as a sigmoid function. In addition, in some implementations, the system trains the artificial neural network using a Levenberg-Marquardt algorithm and a Bayesian regularization backpropagation algorithm. The system iteratively determines the weights of each layer of the artificial neural network by minimizing a difference between the predicted rock properties, where the predicted rock properties are the outputs of the artificial neural network, and the measured rock properties from the core samples.

In general, and specifically for the case of the artificial neural network, the system trains and validates the machine learning on a dataset that includes historical wireline data (i.e., wireline logs from the one or more first wells) and a corresponding core-log dataset (i.e., the core sample measurements from each of the one or more first wells). The core-log data from the one or more first wells represent a set of ground truth values corresponding to a set of predicted rock properties.

The system runs (208) a logging tool down a second well and, using the machine learning model trained on the correlated wireline logs-reservoir rock properties data of the one or more first wells, generates a set of predicted rock properties of the second well. The machine learning model learns the relationship between the wireline logs, where the wireline logs are obtained from one or more first wells, and the reservoir rock properties data, where the reservoir rock properties data is obtained from core samples from the one or more first wells.

In some implementations, the machine learning model is an artificial neural network. The artificial neural network includes a set of parameters that transforms a wireline log obtained from the second well into a predicted set of rock properties of the second well, where the parameters are learned from the correlation between the wireline logs and rock properties from core samples from the one or more first wells.

The system determines (210) a difference between the predicted rock properties of the second well and measured rock properties. The system can compare the peaks and valleys of the predicted rock properties to the peaks and valleys of the measured rock properties. By overlaying the predicted rock properties on the same plot as the measured rock properties on the same depth axis, the difference between each peak and valley correlates to a core-log shift at the corresponding well depth. In some implementations, the measured rock properties include core samples taken from the second well. In some other implementations, the measured rock properties include the wireline log measurement of a correlated property of the second well.

The system applies (212) the difference to generate log depth corrections for each of the rock properties. The system determines the difference by comparing the predicted values of the measured rock properties with the measured values of the rock properties. The system can add the difference to the core measurements to generate a more accurate representation of the rock properties of the second well.

The system generates (214) a pseudo-log of rock properties of the second well based at least in part on applying the log depth corrections to the predicted rock properties. The output of the machine learning model is a continuous representation of one or more predicted rock properties of the second well. The continuous representation is a pseudo-log, where the pseudo-log is a continuous representation of a predicted physical property of the subsurface, and it can be depth-corrected by adding the corresponding log depth corrections as determined by the method described above.

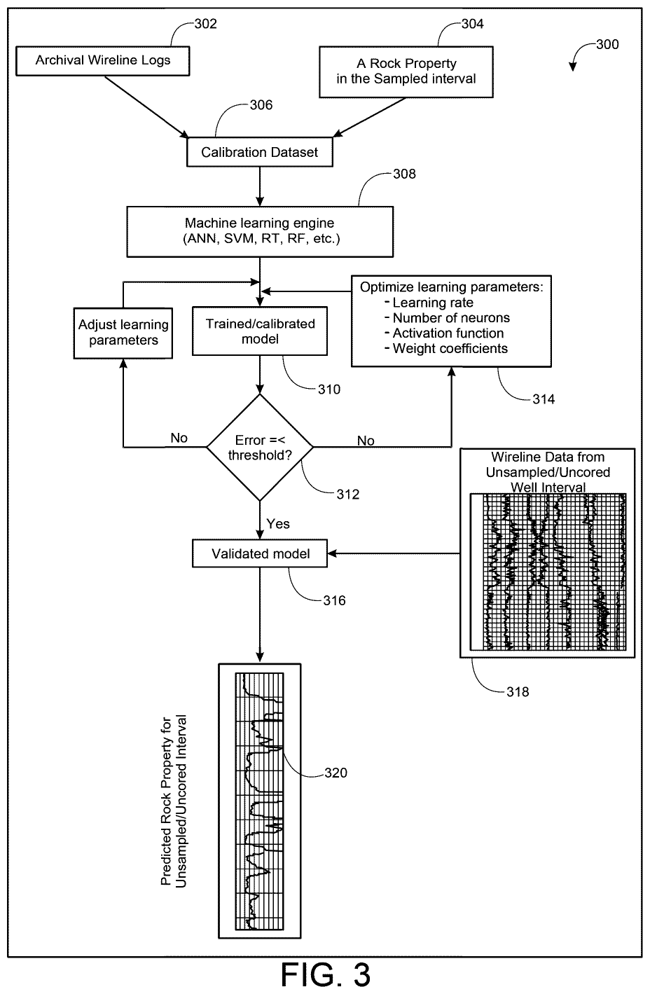

FIG. 3 is a schematic that describes a system 300, where the system 300 implements a series of steps to train a machine learning model to correlate a set of wireline logs 302 from one or more first wells with a set of rock properties from core samples 304 from the one or more first wells.

For each of the one or more first wells, the system 300 combines a dataset of wireline logs 302 (i.e., archival wireline logs) and a data set of rock properties from core samples 304 in the same sampled interval as the wireline logs to form a calibration dataset 306. In some cases, the core samples 304 that produce the set of rock properties are sampled from discrete locations in the well at various depths. Contrastingly, wireline logs (i.e., the wireline logs 302) are often represented as continuous distributions along the depth of the well as the logging tool can evaluate subsurface properties at precise depth intervals.

The system 300 can use the calibration dataset 306 to train a machine learning model 308 to determine a correlation between the wireline logs 302 and core sample 304 dataset. In some implementations, the system 300 can configure the machine learning model 308 as an artificial neural network, a support vector machine, a regression tree, a random forest, an extreme learning algorithm, or type I and type II fuzzy logic. Regardless of the specific architecture used as the machine learning model 308, the system 300 implements a training procedure to determine the parameters of the machine learning model 308 that can be used to map an input wireline log to an output set of physical rock properties. In addition, regardless of the specific architecture used as the machine learning model 308, the system 300 uses the wireline logs 302 of the calibration dataset 306 as the input features to predict a representation of the ground truth values, where the ground truth values are represented by the core sample 304 dataset. The machine learning model generates a continuous set of predicted rock properties along the main axis of the well.

The system can initialize the parameters of the machine learning model, where the initialization can be done randomly or using any other technique. In a first training run, machine learning model 308 generates an output of predicted rock properties 310 and the system 300 determines an error between the values of the predicted rock properties 310 and the ground truth values of the core samples 304 dataset from the calibration dataset 306. For example, the system 300 can determine the error by evaluating the mean square error between the predicted rock properties 310 and the core sample 304 dataset at one or more depths that corresponds to a well from the set of one or more first wells that corresponds to the first training run.

In some implementations, the system 300 can split the calibration dataset 306 into a training dataset and a validation dataset. The training dataset is a first subset of the calibration dataset 306, and the system 300 can use it to train the artificial neural network. The validation dataset is a second subset of the calibration dataset 360, and the system 300 can use it to validate a set of outputs of the artificial neural network.

If the error is greater than a defined error threshold 312, the system 300 can adjust the weights such that it reduces the error on a subsequent training run (i.e., a training run corresponding to a second well of the one or more first wells). In addition, the system 300 can optimize a set of learning parameters 314 such as the learning rate, the number of neurons in the case of a neural network machine learning model, the activation function in the case of a neural network machine learning model, and the weights of the machine learning model. In the case of an artificial neural network architecture as an implementation of the machine learning model 308, the artificial neural network can include one or more hidden layers, where the one or more hidden layers includes a summation layer with a linear function and an activation layer with a sigmoid function. In addition, the system 300 can train the artificial neural using a Levenberg-Marquardt algorithm and a Bayesian regularization backpropagation algorithm, where the system 300 adjusts the weights of each layer of the artificial neural network according to the implemented training algorithms.

If the error is less than or equal to the defined error threshold 312, the training process is complete and the system 300 considers the weights of the machine learning model 308 to be learned. The system 300 can use the validated machine learning model 316 to determine a set of predicted rock values based on an input wireline log. For example, the validated machine learning model 316 can process a wireline log from a unsampled or un-cored well interval 318 to generate a predicted rock property distribution 320 from the same interval.

As new wireline data and corresponding core samples are available, the system 300 can retrain the artificial neural network with new training data, where the training data is a subset of an updated calibration dataset (i.e., calibration dataset 306) to update a set of weights corresponding to a nonlinear function of the artificial neural network.

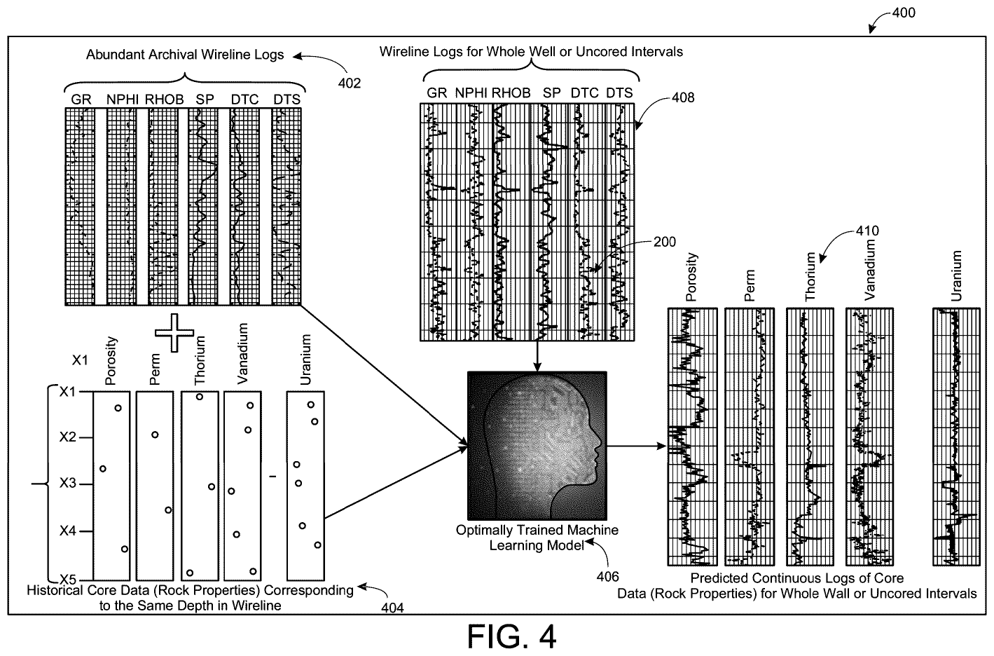

FIG. 4 is an illustration of the training data used to train the machine learning model and the input and output data processed by the trained machine learning model. As described in relation to FIG. 3, the machine learning model is trained on a calibration dataset (i.e., the calibration dataset 306), where the calibration dataset includes wireline logs and corresponding core samples of the one or more first wells.

A set of wireline logs 402 corresponding to a first well of the one or more first wells is an example of one of the entries of the calibration dataset used to train the machine learning model 404. The set of wireline logs 402 can include logs obtained from multiple wireline logging tools to reflect wireline log parameters such as gamma ray (GR), neutron porosity (NPHI), density (RHOB), spontaneous potential (SP), sonic compression (DTC), and sonic shear (DTS). Each wireline log of the set of wireline logs 402 displays a vertical axis that represents the well depth and a horizontal axis that represents the value of the corresponding wireline log parameter. In some implementations, the set of wireline logs 402 is an example of a set of wireline logs from a wireline log archive.

A set of core samples 404 corresponding to the first well of the one or more first wells is an example of an entry of the calibration dataset used to train the machine learning model 404, where the set of core samples 404 corresponds to the same first well described by the set of wireline logs 402. The set of core samples 404 include measurements of rock properties of the subsurface such as porosity, permeability, and elemental composition (i.e., Thorium, Vanadium, and Uranium). Each core sample from the set of core samples 404 displays a vertical axis that represents the well depth and a horizontal axis that represents the value of the corresponding rock property. The well depth represented by the vertical axis is the same well depth as depicted in the set of wireline logs 402.

The set of wireline logs 402 and the set of core samples 404, each corresponding to the same first well of the one or more first wells, is an example entry of a training dataset used to train the machine learning model 406. The set of core samples 404 represents the ground truth data, where the machine learning model 406 learns to correlate the features of an input set of wireline logs 408 to predict an output set of rock properties 410.

In some implementations, the input set of wireline logs 408 may be from an input well with no core samples or un-cored intervals. The machine learning model 406 can generate the output set of rock properties 410 for the entire input well despite not being provided the core samples for the entire depth of the input well.

As more wireline logs and corresponding core samples become available to train the machine learning model 404, the machine learning model 404 will more accurately identify the patterns hidden in them. For example, the data represented in FIG. 4 include wireline logs from more than 3,000 wells.

An accurate core-log depth correction ensures the properties represented by the wireline logs (e.g., wireline logs 402) correspond to the respective rock properties 410 at the appropriate depths. By processing the wireline logs 402 with the machine learning model 404 that takes advantage of multiple variables and features to predict the corresponding rock properties 410 (e.g., not relying solely on gamma ray levels), the approach can take advantage of core samples that have not been scanned for gamma ray levels.

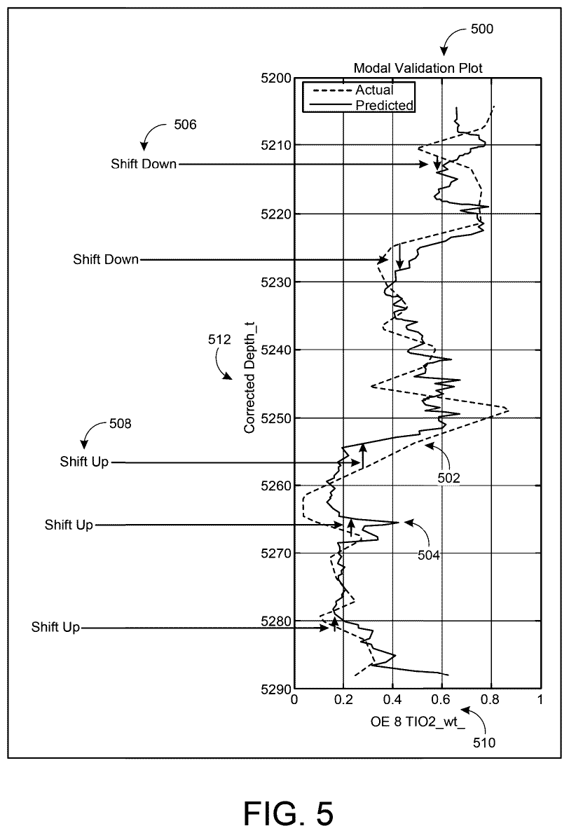

FIG. 5 is a plot 500 of a first dataset 502 that represents measured values at multiple depths of TiO₂ in a subsurface of a well obtained through core samples and a second dataset 504 that represents predicted values at multiple depths of TiO₂ in the subsurface of the well obtained through processing a wireline log with a machine learning model.

The horizontal axis 510 represents the measured value of TiO₂ in the subsurface and the vertical axis 512 represents the well depth where the logging tool obtained the wireline log measurement and core extraction tool obtained the core sample.

The plot 500 displays the two datasets (the first dataset 502 and the second dataset 504) on the same axis to demonstrate the vertical shift between the two datasets. By comparing the vertical position in the well where a peak occurs in the first dataset 502 to the vertical position in the well where a peak occurs in the second dataset 504, a core-log depth correction for the evaluation of TiO₂ can be determined. For example, a shift down 506 between the first dataset 502 and the second dataset 504 is illustrated by comparing the vertical positions of the peak value of TiO₂. As another example, a shift up 508 between the first dataset 502 and the second dataset 504 is illustrated by comparing the vertical positions of the peak values of TiO₂. Multiple shifts, where each shift includes a direction and a magnitude, can be determined throughout the full depth of the well by comparing the vertical positions of minima and maxima between the first dataset 502 and the second dataset 504, where the first dataset 502 corresponds to a set of measurements obtained from core samples and the second dataset 504 corresponds to a set of predicted rock values obtained through processing a wireline log with a machine learning model.

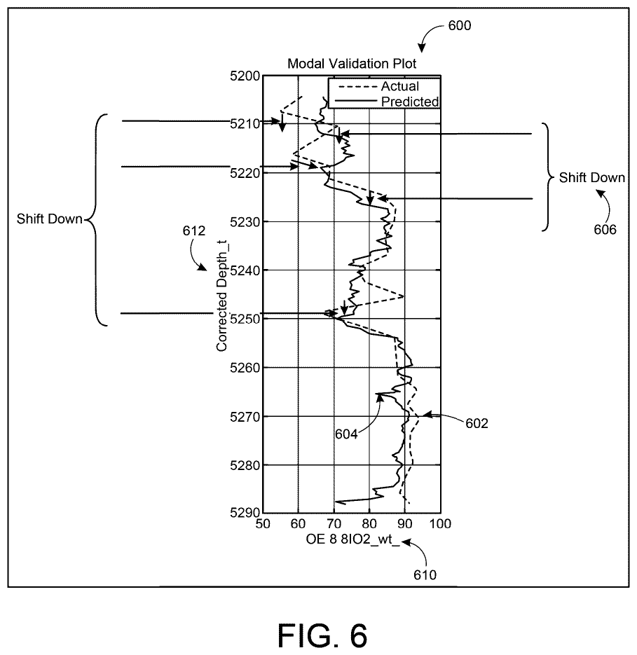

FIG. 6 is a plot 600 of a first dataset 602 that represents measured values at multiple depths of SiO₂ in a subsurface of a well obtained through core samples and a second dataset 604 that represents predicted values at multiple depths of SiO₂ in the subsurface of the well obtained through processing a wireline log with a machine learning model.

The horizontal axis 610 represents the measured value of SiO₂ in the subsurface and the vertical axis 612 represents the well depth where the logging tool obtained the wireline log measurement and core extraction tool obtained the core sample.

The plot 600 displays the two datasets (the first dataset 602 and the second dataset 604) on the same axis to demonstrate the vertical shift between the two datasets. By comparing the vertical position in the well where a peak occurs in the first dataset 602 to the vertical position in the well where a peak occurs in the second dataset 604, a core-log depth correction for the evaluation of SiO₂ can be determined. In this example, the second dataset 604 is consistently shifted down relative to the first dataset 602 over the full depth of the well, unlike the example illustrated in relation to FIG. 5. For example, multiple shifts down 606 between the first dataset 602 and the second dataset 604 are illustrated by comparing the vertical positions of the peak value of SiO₂. Multiple shifts, where each shift includes a direction and a magnitude, can be determined throughout the full depth of the well by comparing the vertical positions of minima and maxima between the first dataset 602 and the second dataset 604, where the first dataset 602 corresponds to a set of measurements obtained from core samples and the second dataset 604 corresponds to a set of predicted rock values obtained through processing a wireline log with a machine learning model.

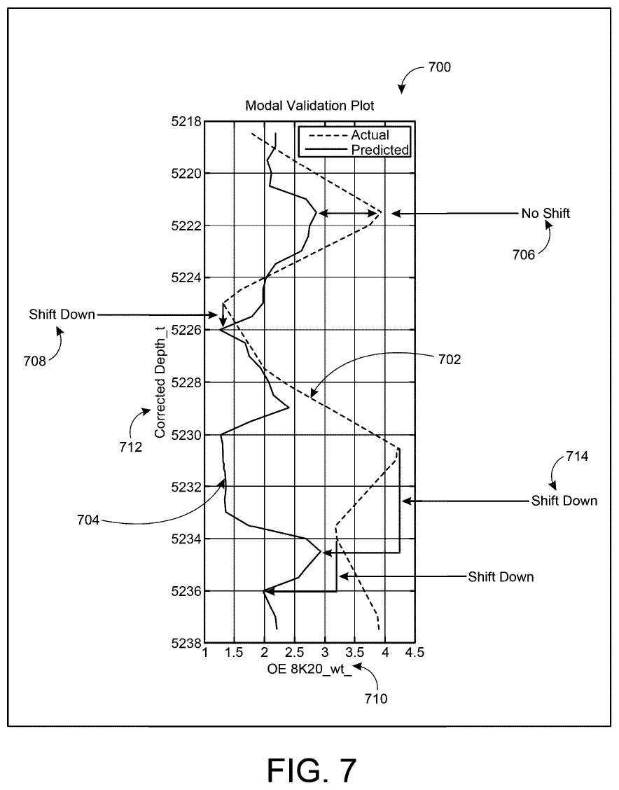

FIG. 7 is a plot 700 of a first dataset 702 that represents measured values at multiple depths of K₂O in a subsurface of a well obtained through core samples and a second dataset 704 that represents predicted values at multiple depths of K₂O in the subsurface of the well obtained through processing a wireline log with a machine learning model.

The horizontal axis 710 represents the measured value of K₂O in the subsurface and the vertical axis 712 represents the well depth where the logging tool obtained the wireline log measurement and core extraction tool obtained the core sample.

The plot 700 displays the two datasets (the first dataset 702 and the second dataset 704) on the same axis to demonstrate the vertical shift between the two datasets. By comparing the vertical position in the well where a peak occurs in the first dataset 702 to the vertical position in the well where a peak occurs in the second dataset 704, a core-log depth correction for the evaluation of K₂O can be determined. For example, a shift down 708 between the first dataset 702 and the second dataset 704 is illustrated by comparing the vertical positions of the peak value of K₂O. As another example, a significant shift down 714 between the first dataset 702 and the second dataset 704 is illustrated by comparing the vertical positions of the minima values of K₂O. As another example, the maxima and minima of the measured value of K₂O can be vertically aligned between the first dataset 702 and the second dataset 704 as illustrated by the no shift 706. Multiple shifts, where each shift includes a direction and a magnitude, where the magnitude includes zero shift, can be determined throughout the full depth of the well by comparing the vertical positions of minima and maxima between the first dataset 702 and the second dataset 704, where the first dataset 702 corresponds to a set of measurements obtained from core samples and the second dataset 704 corresponds to a set of predicted rock values obtained through processing a wireline log with a machine learning model.

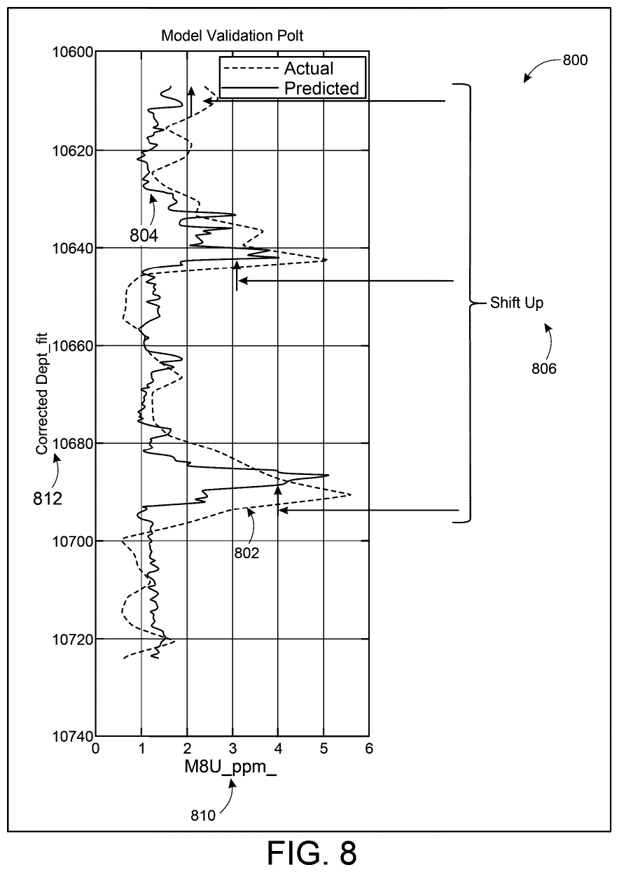

FIG. 8 is a plot 800 of a first dataset 802 that represents measured values at multiple depths of Uranium in a subsurface of a well obtained through core samples and a second dataset 804 that represents predicted values at multiple depths of Uranium in the subsurface of the well obtained through processing a wireline log with a machine learning model.

The horizontal axis 810 represents the measured value of Uranium in the subsurface and the vertical axis 812 represents the well depth where the logging tool obtained the wireline log measurement and core extraction tool obtained the core sample.

The plot 800 displays the two datasets (the first dataset 802 and the second dataset 804) on the same axis to demonstrate the vertical shift between the two datasets. By comparing the vertical position in the well where a peak occurs in the first dataset 802 to the vertical position in the well where a peak occurs in the second dataset 804, a core-log depth correction for the evaluation of Uranium can be determined. For example, multiple shifts up 806 between the first dataset 802 and the second dataset 804 are illustrated by comparing the vertical positions of the peak values of Uranium. In this example, there is a consistent shift up between the two datasets throughout the full depth of the well. Multiple shifts, where each shift includes a direction and a magnitude, can be determined throughout the full depth of the well by comparing the vertical positions of minima and maxima between the first dataset 802 and the second dataset 804, where the first dataset 802 corresponds to a set of measurements obtained from core samples and the second dataset 804 corresponds to a set of predicted rock values obtained through processing a wireline log with a machine learning model.

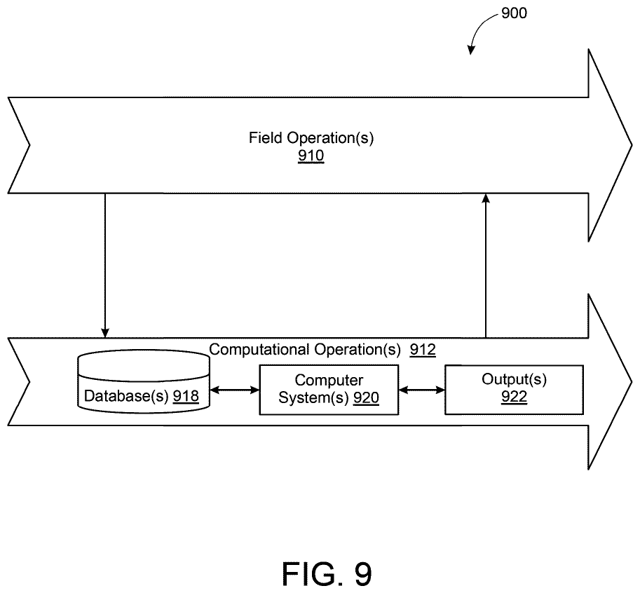

FIG. 9 illustrates hydrocarbon production operations 900 that include both one or more field operations 910 and one or more computational operations 912, which exchange information and control exploration to produce hydrocarbons. In some implementations, outputs of techniques of the present disclosure (e.g., the method 200) can be performed before, during, or in combination with the hydrocarbon production operations 900, specifically, for example, either as field operations 910 or computational operations 912, or both. For example, the process 200 collect data during field operations, processes the data in computational operations, and can determine locations to perform additional field operations.

Examples of field operations 910 include forming/drilling a wellbore, hydraulic fracturing, producing through the wellbore, injecting fluids (such as water) through the wellbore, to name a few. In some implementations, methods of the present disclosure can trigger or control the field operations 910. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 910 and responsively triggering the field operations 910 including, for example, generating plans and signals that provide feedback to and control physical components of the field operations 910. Alternatively, or in addition, the field operations 910 can trigger the methods of the present disclosure. For example, implementing physical components (including, for example, hardware, such as sensors) deployed in the field operations 910 can generate plans and signals that can be provided as input or feedback (or both) to the methods of the present disclosure.

Examples of computational operations 912 include one or more computer systems 920 that include one or more processors and computer-readable media (e.g., non-transitory computer-readable media) operatively coupled to the one or more processors to execute computer operations to perform the methods of the present disclosure. The computational operations 912 can be implemented using one or more databases 918, which store data received from the field operations 910 and/or generated internally within the computational operations 912 (e.g., by implementing the methods of the present disclosure) or both. For example, the one or more computer systems 920 process inputs from the field operations 910 to assess conditions in the physical world, the outputs of which are stored in the databases 918. For example, seismic sensors of the field operations 910 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 912 where they are stored in the databases 918 and analyzed by the one or more computer systems 920.

In some implementations, one or more outputs 922 generated by the one or more computer systems 920 can be provided as feedback/input to the field operations 910 (either as direct input or stored in the databases 918). The field operations 910 can use the feedback/input to control physical components used to perform the field operations 910 in the real world.

For example, the computational operations 912 can process the seismic data to generate three-dimensional (3D) maps of the subsurface formation. The computational operations 912 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 912 to process new information about the formation and control the drilling to adjust to the observed conditions in real-time.

The one or more computer systems 920 can update the 3D maps of the subsurface formation as information from one exploration well is received and the computational operations 912 can adjust the location of the next exploration well based on the updated 3D maps. Similarly, the data received from production operations can be used by the computational operations 912 to control components of the production operations. For example, production well and pipeline data can be analyzed to predict slugging in pipelines leading to a refinery and the computational operations 912 can control machine operated valves upstream of the refinery to reduce the likelihood of plant disruptions that run the risk of taking the plant offline.

In some implementations of the computational operations 912, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 10 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

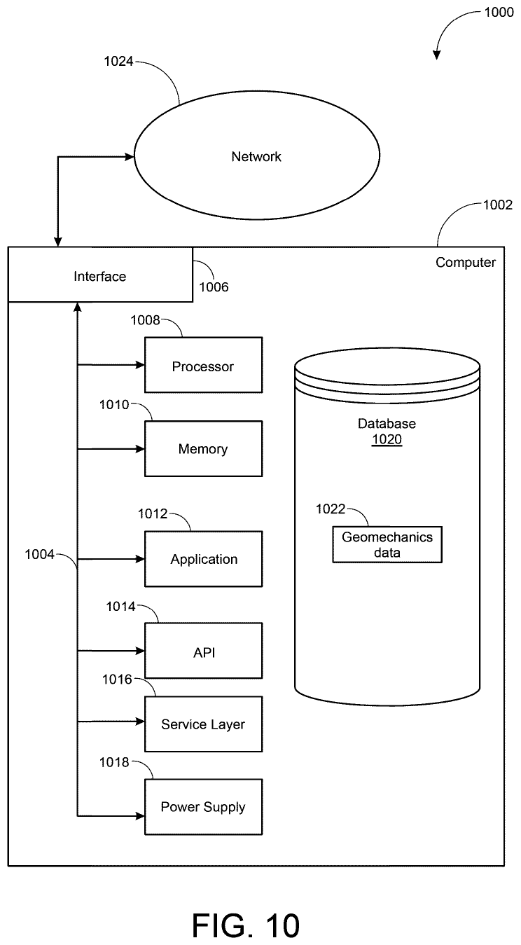

FIG. 10 is a block diagram of an example computer system 1000 used to provide computational functionalities associated with described algorithms, methods, functions, processes, flows, and procedures described in the present disclosure, according to some implementations of the present disclosure. The illustrated computer 1002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1002 can include input devices such as keypads, keyboards, and touch screens that can accept user information. Also, the computer 1002 can include output devices that can convey information associated with the operation of the computer 1002. The information can include digital data, visual data, audio information, or a combination of information. The information can be presented in a graphical user interface (UI) (or GUI).

The computer 1002 can serve in a role as a client, a network component, a server, a database, a persistency, or components of a computer system for performing the subject matter described in the present disclosure. The illustrated computer 1002 is communicably coupled with a network 1024. In some implementations, one or more components of the computer 1002 can be configured to operate within different environments, including cloud-computing-based environments, local environments, global environments, and combinations of environments.

At a high level, the computer 1002 is an electronic computing device operable to receive, transmit, process, store, and manage data and information associated with the described subject matter. According to some implementations, the computer 1002 can also include, or be communicably coupled with, an application server, an email server, a web server, a caching server, a streaming data server, or a combination of servers.

The computer 1002 can receive requests over network 1024 from a client application (for example, executing on another computer 1002). The computer 1002 can respond to the received requests by processing the received requests using software applications. Requests can also be sent to the computer 1002 from internal users (for example, from a command console), external (or third) parties, automated applications, entities, individuals, systems, and computers.

Each of the components of the computer 1002 can communicate using a system bus 1004. In some implementations, any or all of the components of the computer 1002, including hardware or software components, can interface with each other or the interface 1006 (or a combination of both), over the system bus 1004. Interfaces can use an application programming interface (API) 1014, a service layer 1016, or a combination of the API 1014 and service layer 1016. The API 1014 can include specifications for routines, data structures, and object classes. The API 1014 can be either computer-language independent or dependent. The API 1014 can refer to a complete interface, a single function, or a set of APIs.

The service layer 1016 can provide software services to the computer 1002 and other components (whether illustrated or not) that are communicably coupled to the computer 1002. The functionality of the computer 1002 can be accessible for all service consumers using this service layer. Software services, such as those provided by the service layer 1016, can provide reusable, defined functionalities through a defined interface. For example, the interface can be software written in JAVA, C++, or a language providing data in extensible markup language (XML) format. While illustrated as an integrated component of the computer 1002, in alternative implementations, the API 1014 or the service layer 1016 can be stand-alone components in relation to other components of the computer 1002 and other components communicably coupled to the computer 1002. Moreover, any or all parts of the API 1014 or the service layer 1016 can be implemented as child or sub-modules of another software module, enterprise application, or hardware module without departing from the scope of the present disclosure.

The computer 1002 includes an interface 1006. Although illustrated as a single interface 1006 in FIG. 10, two or more interfaces 1006 can be used according to implementations of the computer 1002 and the described functionality. The interface 1006 can be used by the computer 1002 for communicating with other systems that are connected to the network 1024 (whether illustrated or not) in a distributed environment. Generally, the interface 1006 can include, or be implemented using, logic encoded in software or hardware (or a combination of software and hardware) operable to communicate with the network 1024. More specifically, the interface 1006 can include software supporting one or more communication protocols associated with communications. As such, the network 1024 or the interface's hardware can be operable to communicate physical signals within and outside of the illustrated computer 1002.

The computer 1002 includes a processor 1008. Although illustrated as a single processor 1008 in FIG. 10, two or more processors 1008 can be used according to implementations of the computer 1002 and the described functionality. Generally, the processor 1008 can execute instructions and can manipulate data to perform the operations of the computer 1002, including operations using algorithms, methods, functions, processes, flows, and procedures as described in the present disclosure.

The computer 1002 also includes a database 1020 that can hold data (such geomechanics data 1022) for the computer 1002 and other components connected to the network 1024 (whether illustrated or not). For example, database 1020 can be in-memory or a database storing data consistent with the present disclosure. In some implementations, database 1020 can be a combination of two or more different database types (for example, hybrid in-memory and conventional databases) according to implementations of the computer 1002 and the described functionality. Although illustrated as a single database 1020 in FIG. 10, two or more databases (of the same, different, or combination of types) can be used according to implementations of the computer 1002 and the described functionality. While database 1020 is illustrated as an internal component of the computer 1002, in alternative implementations, database 1020 can be external to the computer 1002.

The computer 1002 also includes a memory 1010 that can hold data for the computer 1002 or a combination of components connected to the network 1024 (whether illustrated or not). Memory 1010 can store any data consistent with the present disclosure. In some implementations, memory 1010 can be a combination of two or more different types of memory (for example, a combination of semiconductor and magnetic storage) according to implementations of the computer 1002 and the described functionality. Although illustrated as a single memory 1010 in FIG. 10, two or more memories 1010 (of the same, different, or combination of types) can be used according to implementations of the computer 1002 and the described functionality. While memory 1010 is illustrated as an internal component of the computer 1002, in alternative implementations, memory 1010 can be external to the computer 1002.

The application 1012 can be an algorithmic software engine providing functionality according to implementations of the computer 1002 and the described functionality. For example, application 1012 can serve as one or more components, modules, or applications. Further, although illustrated as a single application 1012, the application 1012 can be implemented as multiple applications 1018 on the computer 1002. In addition, although illustrated as internal to the computer 1002, in alternative implementations, the application 1012 can be external to the computer 1002.

The computer 1002 can also include a power supply 1018. The power supply 1018 can include a rechargeable or non-rechargeable battery that can be configured to be either user- or non-user-replaceable. In some implementations, the power supply 1018 can include power-conversion and management circuits, including recharging, standby, and power management functionalities. In some implementations, the power-supply 1018 can include a power plug to allow the computer 1002 to be plugged into a wall socket or a power source to, for example, power the computer 1002 or recharge a rechargeable battery.

There can be any number of computers 1002 associated with, or external to, a computer system including the computer 1002, with each computer 1002 communicating over network 1024. Further, the terms “client,” “user,” and other appropriate terminology can be used interchangeably, as appropriate, without departing from the scope of the present disclosure. Moreover, the present disclosure contemplates that many users can use one computer 1002 and one user can use multiple computers 1002.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the spirit and scope of this disclosure. Accordingly, other embodiments are within the scope of the following claims.

### Examples

In some implementations, methods include exploring for hydrocarbons in a reservoir, the method comprising obtaining wireline logs for one or more first wells, obtaining reservoir rock property data from core samples from the one or more first wells, correlating the wireline logs with the measured reservoir rock properties, running a logging tool down a second well to generate wireline logs for the second well, processing the wireline logs for the second well using a machine learning model trained on the correlated wireline logs-reservoir rock properties data of the one or more first wells to generate a set of predicted rock properties of the second well, determining a difference between the predicted rock properties of the second well and measured rock properties, applying the difference to generate log depth corrections for each of the rock properties, and generating a pseudo-log of rock properties of the second well based at least in part on applying the log depth corrections to the predicted rock properties.

In an example implementation combinable with any other implementation, the reservoir rock pro property data includes porosity, permeability, grain density, and geochemical and elemental data,

In an example implementation combinable with any other implementation, the machine learning model generates a continuous set of predicted rock properties along the main axis of the well.

In an example implementation combinable with any other implementation, the machine learning model is an artificial neural network.

In an example implementation combinable with any other implementation, the artificial neural network includes one or more hidden layers, the one or more hidden layers including a summation layer comprising a linear function and an activation layer comprising a sigmoid function.

In an example implementation combinable with any other implementation, the artificial neural network is trained using a Levenberg-Marquardt algorithm and a Bayesian regularization backpropagation algorithm.

In an example implementation combinable with any other implementation, a dataset comprising wireline data from one or more wells and a corresponding core sample dataset from the one or more wells are used to train and validate the artificial neural network, the wireline data representing input data processed by the artificial neural network, the core sample data representing a set of ground truth values corresponding to a set of predicted rock values.

In an example implementation combinable with any other implementation, the dataset is split into a training dataset and a validation dataset, the training dataset used to train the artificial neural network, the validation dataset used to validate a set of outputs of the artificial neural network.

In an example implementation combinable with any other implementation, the artificial neural network is retrained with new training data to update a set of weights corresponding to a nonlinear function of the artificial neural network.

In some implementations, methods include exploring a reservoir containing hydrocarbons, the method comprising obtaining wireline log data from a well, processing the wireline log data using a machine learning model to generate a set of predicted rock properties of the well, determining a difference between the wireline log data and the set of predicted rock properties of the well, applying the difference to generate log depth corrections for each of the rock properties, and generating a pseudo-log of rock properties of the second well based at least in part on applying the log depth corrections to the predicted rock properties.

In an example implementation combinable with any other implementation, rock properties include porosity, permeability, grain density, and geochemical and elemental data.

In an example implementation combinable with any other implementation, the machine learning model generates a continuous set of predicted rock properties along the main axis of the well.

In an example implementation combinable with any other implementation, the machine learning model is an artificial neural network.

In an example implementation combinable with any other implementation, the artificial neural network includes one or more hidden layers, the one or more hidden layers including a summation layer comprising a linear function and an activation layer comprising a sigmoid function.

In an example implementation combinable with any other implementation, the artificial neural network is trained using a Levenberg-Marquardt algorithm and a Bayesian regularization backpropagation algorithm.

In an example implementation combinable with any other implementation, a dataset comprising wireline data from one or more wells and a corresponding core sample dataset from the one or more wells are used to train and validate the artificial neural network, the wireline data representing input data processed by the artificial neural network, the core sample data representing a set of ground truth values corresponding to a set of predicted rock values.

In an example implementation combinable with any other implementation, the dataset is split into a training dataset and a validation dataset, the training dataset used to train the artificial neural network, the validation dataset used to validate a set of outputs of the artificial neural network.

In an example implementation combinable with any other implementation, the artificial neural network is retrained with new training data to update a set of weights corresponding to a nonlinear function of the artificial neural network.

What is claimed is:

1. A method of exploring for hydrocarbons in a reservoir, the method comprising:
obtaining wireline logs for one or more first wells;
obtaining reservoir rock property data from core samples from the one or more first wells;
correlating the wireline logs with the measured reservoir rock properties;
running a logging tool down a second well to generate wireline logs for the second well;
processing the wireline logs for the second well using a machine learning model trained on the correlated wireline logs-reservoir rock properties data of the one or more first wells to generate a set of predicted rock properties of the second well;
determining a difference between the predicted rock properties of the second well and measured rock properties;
applying the difference to generate log depth corrections for each of the rock properties; and
generating a pseudo-log of rock properties of the second well based at least in part on applying the log depth corrections to the predicted rock properties.

2. The method of claim 1, wherein reservoir rock property data includes porosity, permeability, grain density, and geochemical and elemental data.

3. The method of claim 1, wherein the machine learning model generates a continuous set of predicted rock properties along the main axis of the well.

4. The method of claim 1, wherein the machine learning model is an artificial neural network.

5. The method of claim 4, wherein the artificial neural network includes one or more hidden layers, the one or more hidden layers including a summation layer comprising a linear function and an activation layer comprising a sigmoid function.

6. The method of claim 4, wherein the artificial neural network is trained using a Levenberg-Marquardt algorithm and a Bayesian regularization backpropagation algorithm.

7. The method of claim 4, wherein a dataset comprising wireline data from one or more wells and a corresponding core sample dataset from the one or more wells are used to train and validate the artificial neural network, the wireline data representing input data processed by the artificial neural network, the core sample data representing a set of ground truth values corresponding to a set of predicted rock values.

8. The method of claim 7, wherein the dataset is split into a training dataset and a validation dataset, the training dataset used to train the artificial neural network, the validation dataset used to validate a set of outputs of the artificial neural network.

9. The method of claim 7, wherein the artificial neural network is retrained with new training data to update a set of weights corresponding to a nonlinear function of the artificial neural network.

10. A method for exploring a reservoir containing hydrocarbons, the method comprising:
obtaining wireline log data from a well;
processing the wireline log data using a machine learning model to generate a set of predicted rock properties of the well;
determining a difference between the wireline log data and the set of predicted rock properties of the well;
applying the difference to generate log depth corrections for each of the rock properties; and
generating a pseudo-log of rock properties of the second well based at least in part on applying the log depth corrections to the predicted rock properties.

11. The method of claim 10, wherein rock properties include porosity, permeability, grain density, and geochemical and elemental data.

12. The method of claim 10, wherein the machine learning model generates a continuous set of predicted rock properties along the main axis of the well.

13. The method of claim 10, wherein the machine learning model is an artificial neural network.

14. The method of claim 13, wherein the artificial neural network includes one or more hidden layers, the one or more hidden layers including a summation layer comprising a linear function and an activation layer comprising a sigmoid function.

15. The method of claim 13, wherein the artificial neural network is trained using a Levenberg-Marquardt algorithm and a Bayesian regularization backpropagation algorithm.

16. The method of claim 13, wherein a dataset comprising wireline data from one or more wells and a corresponding core sample dataset from the one or more wells are used to train and validate the artificial neural network, the wireline data representing input data processed by the artificial neural network, the core sample data representing a set of ground truth values corresponding to a set of predicted rock values.

17. The method of claim 16, wherein the dataset is split into a training dataset and a validation dataset, the training dataset used to train the artificial neural network, the validation dataset used to validate a set of outputs of the artificial neural network.

18. The method of claim 16, wherein the artificial neural network is retrained with new training data to update a set of weights corresponding to a nonlinear function of the artificial neural network.
